(19) United States
(12) Patent Application Publication
(10) Pub. No.: US 2017/0277409 A1
(43) Pub. Date: Sep. 28, 2017

(54) EXTERNAL TIME-ASSOCIATED DATA IN OPERATING SYSTEM INTERFACE

(71) Applicant: Microsoft Technology Licensing, LLC, Redmond, WA (US)

(72) Inventors: Deana R. Nelson, Seattle, WA (US); Shane Wyatt Zamora, Bellevue, WA (US); Song Zou, Bellevue, WA (US); Caitlin Kehoe Hart, Seattle, WA (US); Teresa Thomas, Seattle, WA (US); Christopher S. Bimm, Seattle, WA (US); Akshatha Kommalapati, Kirkland, WA (US); Christopher Doan, Seattle, WA (US)

(21) Appl. No.: 15/136,402

(22) Filed: Apr. 22, 2016

Related U.S. Application Data
(60) Provisional application No. 62/312,351, filed on Mar. 23, 2016.

(51) Int. Cl. G06F 3/0484; G06Q 10/10; G06F 17/30; G06F 3/0482

(52) U.S. Cl. CPC G06F 3/04845; G06F 3/04842; G06F 3/0482; G06Q 10/1095; G06F 17/30551; G06F 2203/04803

(57) ABSTRACT

An operating system that includes a time user interface module that presents a time user interface on a display. The time user interface allowing a change in focal date and displays external time-associated data as instructed. An application program interface communicatively couples one or more non-native programs with the time user interface module, to thereby allow the one or more non-native programs to provide time-associated data and corresponding presentation instructions to the time user interface module. This causes the time user interface to display the external time-associated data sourced from a non-native program responsive to instructions from the non-native program.

### CROSS REFERENCE TO RELATED APPLICATIONS

This application claims the benefit of U.S. Provisional Application Ser. No. 62/312,351, filed Mar. 23, 2016, which provisional patent application is incorporated herein by reference in its entirety.

### BACKGROUND

Computers and networks have ushered in what has been called the “information age”. There is a massive quantity of data available that can assist users in managing their life. When it comes to managing life (or any sequence of events), an important type of data is referred to herein as “time-associated data”. Time associated data is data (such as appointments, reminders, log entries, pictures, videos, and so forth) that have a time associated with it.

The operating system itself often provides a time user interface that the user activates and interfaces with in a consistent way. By way of example, in WINDOWS 10, for instance, a time user interface can be activated by a user clicking on the time displayed in the right extreme of the task bar. Such a user interaction will cause the operating system to reveal the time user interface. The time user interface shows the current time, a month view that highlights the current date, and a control that allows the user to see month views for different months of the same and different years.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to use of a time user interface that is inherent to the operating system to display time-associated data sourced from one or more programs. The program that provides the time-associated data also provides presentation instructions to the operating system on how the time-associated data is to be presented in time user interface.

A program or computer program can refer to a local or remote application or service that can communicate with an operating system to receive common services. In this regard, the program that provides the time-associated data and associated presentation instruction can be described as being external to the operating system in that the program is not inherent to of the operating system software.

As mentioned, the external program that sources the time-associated data also provides the presentation instructions to the operating system on how the time-associated data should be presented in the time user interface. Accordingly, the time user interface can be a common service of the operating system to facilitate the display of external time-associated data (from external program(s)) in the time user interface. In one example, the time user interface may be displayed in a consistent location of a display of the operating system, regardless of the programs that are running.

The time user interface also has a focal date that is visually emphasized and that can change depending on user interaction. For instance, the focal date may by default be the current date, but a user could change the focal date by navigating through the time user interface. As the focal date changes, so does the time-associated data that populates the time user interface. Accordingly, when the user interacts with the time user interface to change the focal date, the relevant external time-associated data within the time user interface also changes. Furthermore, the changed time-associated data is presented considering the corresponding presentation instructions provided by the program.

Thus, the user can get a sense of the time-associated data related to any date as desired by the user, and may obtain such data via an operating system-based user interface. In embodiments, the operating system supports an Application Programming Interface (API) as a common tool for external programs to communicatively couple with the time user interface. A program can identify time-associated data based on the API and may also use the API to communicate the time-associated data to the operating system for display via the time user interface. This provides a consistent mechanism for a user to access time-associated data, regardless of the source of the time-associated data being external to the operating system, regardless of the focal date, and regardless of what programs are running in the operating system. Furthermore, navigation through focal dates to see different external time-associated data can be performed in a consistent manner based on interaction with the operating system.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates an architecture of a computing system that displays a time user interface when the operating system is triggered to do so, and in which the triggering component causes the time user interface module to display a time user interface;

FIG. 3 illustrates an example user interface that includes a control that may be interfaced with in order to cause the triggering component to trigger the time user interface module to present the time user interface;

FIG. 4 illustrates an example time user interface that shows a month view with the current date highlighted; and a current time view that shows the time to the second;

FIG. 5 illustrates an architecture of a computing system that displays a time user interface when the operating system is triggered to do so, and which time user interface is populated with time-associated data from sources external to the operating system;

FIG. 6 illustrates a time user interface that represents an example of the time user interface of FIG. 5, and which includes a time-associated data portion that is populated to time-associated data related to the focal date of the time user interface;

FIG. 7 illustrates a time user interface that is similar to that of FIG. 6, except that the focal date has been changed, causing a corresponding change in the time-associated data populated into the time-associated data portion of the time user interface;

FIG. 8 illustrates a user interface of an application that may be launched by a user interfacing with the time-associated data portion of the time user interface of FIG. 6 or 7;

FIG. 9 illustrates a flowchart of a method 900 for collecting time-associated data sourced from external to the operating system; and

FIG. 10 illustrates a flowchart of a method for presenting an operating system native time user interface that displays time-associated data sourced from external to the operating system and that depends on a focal date of the time user interface, and in a display manner as instructed from a non-native program.

### DETAILED DESCRIPTION

At least some embodiments described herein relate to use of a time user interface that is inherent to the operating system to display time-associated data sourced from one or more programs. The program that provides the time-associated data also provides presentation instructions to the operating system on how the time-associated data is to be presented in time user interface.

The time user interface is “inherent to” the operating system as it is provided by an executable component (called herein a “time user interface module”) that is inherent to or native to the operating system. An executable component is “inherent to” or “native to” the operating system when it is either 1) installed as part of the installation of the operating system and cannot thereafter be uninstalled independent from uninstallation of the operating system, or 2) installed as part of an update of the operating system and cannot thereafter be uninstalled absent uninstallation of the operating system or reversal of the update of the operating system. Furthermore, an “operating system inherent” executable component, an “operating system native” executable component, or a “native” executable component is defined as an executable component that is native to the operating system as the term “native to” is defined above.

A program or computer program can refer to a local or remote application or service that can communicate with an operating system to receive common services. In this regard, the program that provides the time-associated data and associated presentation instruction can be described as being external to the operating system in that the program is not inherent to the operating system software. That is to say that the program can be installed independent of installing or updating the operating system. For a remote program, the remote program may exist independent of the existence of the operating system.

As mentioned, the external program that sources the time-associated data also provides the presentation instructions to the operating system on how the time-associated data should be presented in the time user interface. Accordingly, the time user interface can be a common service of the operating system to facilitate the display of external time-associated data (from external program(s)) in the time user interface. In one example, the time user interface module may be displayed in a consistent location of a display of the operating system regardless of the programs that are running.

The time user interface also has a focal date that is visually emphasized and that can change depending on user interaction. For instance, the focal date may by default be the current date, but a user could change the focal date by navigating through the time user interface. As the focal date changes, so does the time-associated data that populates the time user interface. Accordingly, when the user interacts with the time user interface to change the focal date, the relevant external time-associated data within the time user interface also changes. Furthermore, the changed time-associated data is presented considering the corresponding presentation instructions provided by the program.

Thus, the user can get a sense of the time-associated data related to any date as desired by the user, and may obtain such data via an operating system-based user interface. In embodiments, the operating system supports an Application Programming Interface (API) as a common tool for external programs to communicatively couple with the time user interface. A program can identify time-associated data based on the API and may also use the API to communicate the time-associated data to the operating system for display via the time user interface. This provides a consistent mechanism for a user to access time-associated data, regardless of the source of the time-associated data being external to the operating system, regardless of the focal date, and regardless of what programs are running in the operating system. Furthermore, navigation through focal dates to see different external time-associated data can be performed in a consistent manner based on interaction with the operating system.

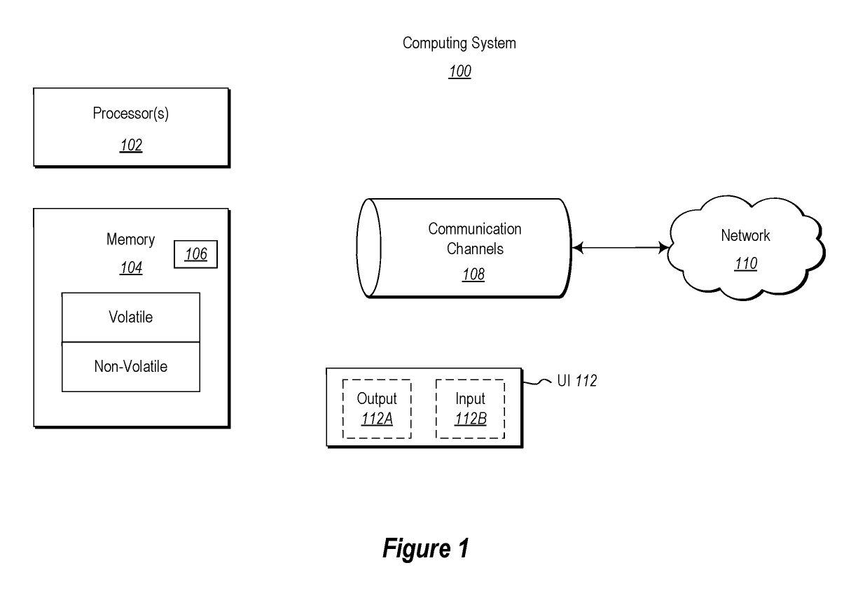

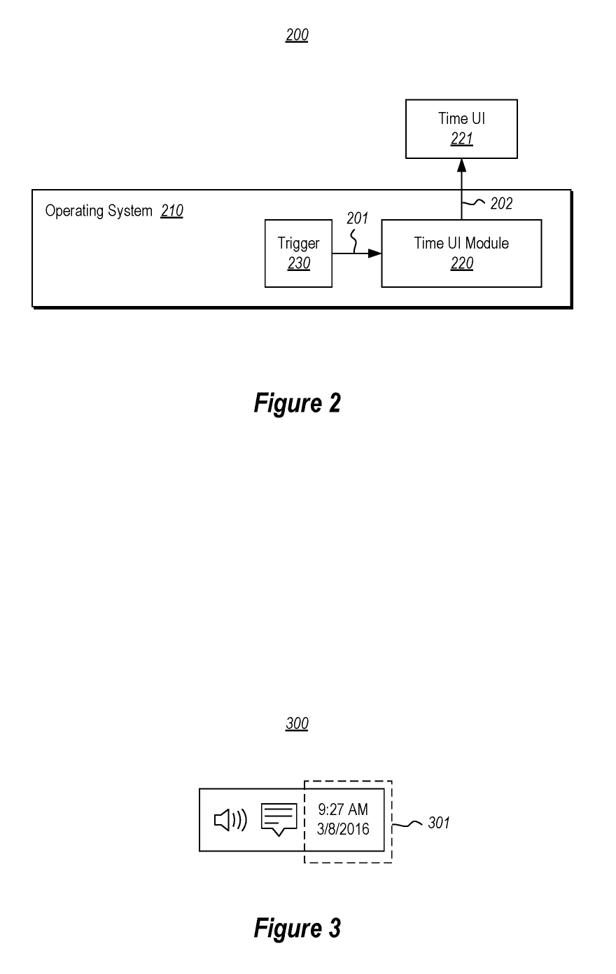

Some introductory discussion of a computing system will be described with respect to FIG. 1. Then, the operation of the presentation of time-associated data sourced from external from an operating system into a time user interface hosted by the operating system will be described with respect to FIGS. 2 through 10.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

FIG. 2 illustrates an architecture 200 of a computing system 200 that displays a time user interface. The architecture 200 includes an operating system 210 that includes an operating system native time user interface module 220. The operating system 210 also includes a triggering component 230 that, when triggered, causes (as represented by arrow 201) the operating system native interface module 220 to present (as represented by arrow 202) a time user interface 221 on a display. For instance, if the computing system 200 were the computing system 100 of FIG. 1, the time user interface 221 may be displayed on a display encompassed within the set of output mechanisms 112A. A user may trigger the operating system native interface module 220 to present the time user interface 221 by interfacing with the triggering component 230 of the operating system 210. The operating system 210, the time user interface module 220, and the triggering component 230 may be structured as described above for the executable component 106 of FIG. 1.

While the principles described herein are not limited to how the time user interface is triggered or represented, FIG. 3 illustrates a user interface 300 that includes a control 301 that may be interfaced with in order to cause the triggering component 230 to trigger the time user interface module 220 to present the time user interface 221. In this embodiment, the control 301 itself actually shows some small representation of the time and date. This allows the user to get some sense of time by simply looking at the control 301, which may be enough for the user's purposes in many circumstances.

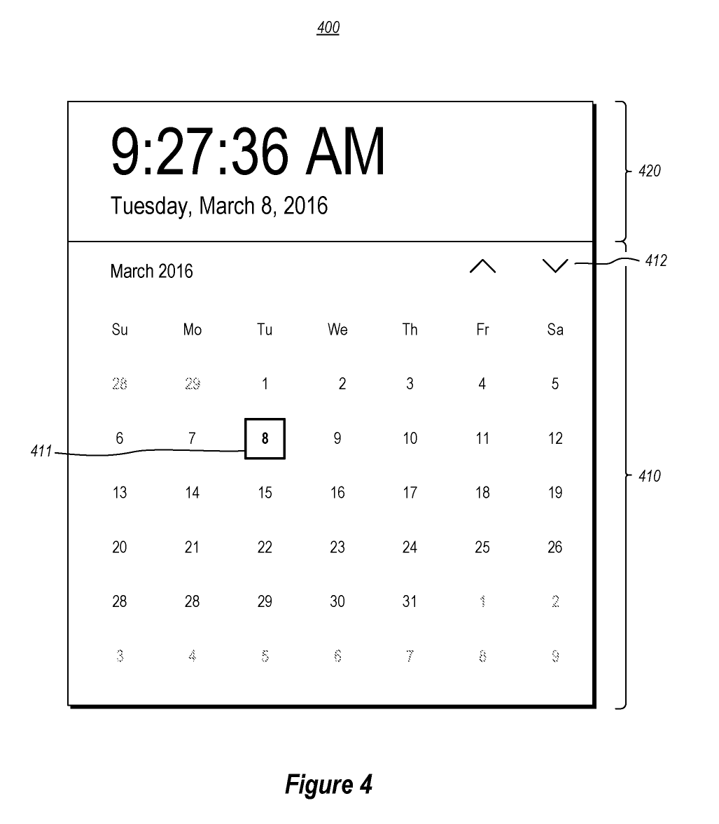

The time user interface 221 may present a more elaborate display of the time and/or date. For instance, FIG. 4 illustrates an example time user interface 400 that is an example of the time user interface 221 that shows a month view 410 with the current date 411 highlighted; and a current time view 420 that shows the time to the second. There are also navigation controls 412 that allow the user to navigate to a different month of the same year, or other months of other years. FIGS. 2 through 4 represent the current state of the art in triggering and displaying a time user interface.

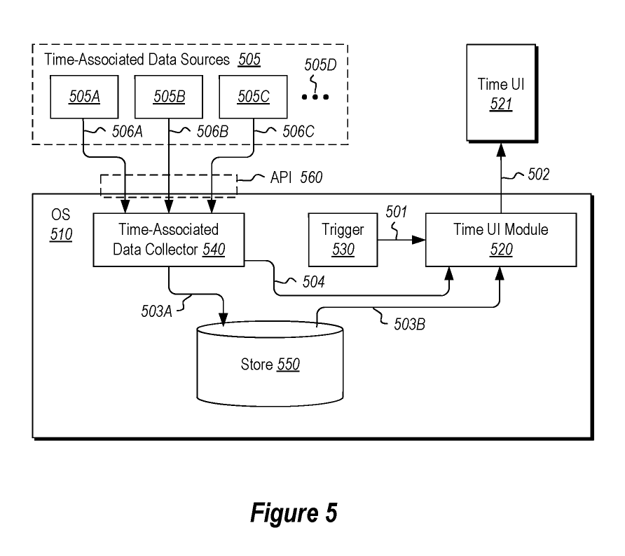

FIG. 5 illustrates an architecture of a computing system 500 that has an operating system 510 that includes an operating system native time user interface module 520 that may be triggered (as represented by arrow 501) by a triggering component 530 to display (as represented by arrow 502) a time user interface 521. However, compared to the operating system 210 of FIG. 2, the operating system 510 of FIG. 5 interacts with various time-associated data sources 505, and includes various additional components that collaborate with the time user interface module 520. This collaboration allows for technical innovations that provide a much more useful time user interface 521 of FIG. 5 as compared to the time user interface 221 of FIG. 2. In particular, the time user interface 521 may be populated with time-associated data coming from external from the operating system itself, and that are presented consistent with presentation instructions externally received by the operating system.

In this description and in the claims, a “time” is to be interpreted broadly to include a single point in time or a range of times. For instance, a date may be thought of as a time as it is a range of times from the beginning of the day to the end of the day. In this description and in the claims, “time-associated data” is any data that has an associated time. For instance, a photograph may have metadata indicating when the photo was taken. A calendar entry may have a time range for an appointment. A reminder application may include, for each event, when the event is to occur, and when the next reminder is to occur. Logs may also have an entry time. Data may also be considered valid until a certain time, and/or may have an associated creation, and/or last modified date. Some pieces of data may be renewable provided renewed by a certain time. The possibilities for time-associated data are limitless.

The operating system 510 includes a time associated data collector module 540 that collects time-associated data (and corresponding presentation instruction) from at least one time-associated data source 505 outside of the operating system. For instance, the operating system 510 may provide an API 560 for interfacing with the time-associated data collector 540 to provide such time-associated data and corresponding presentation instruction. In FIG. 5, there are three time-associated data sources 505A through 505C illustrated. However, the ellipses 505D represent that the collector module 540 may collect time-associated data from any number of sources from as few as one, and with no upper limit contemplated. The time-associated data sources 505 may each be, for instance, programs external to the operating system. The operating system 510, the time user interface module 520, the triggering module 530 and the time associated data collector module 540 may be structured as described above from the executable component 106 of FIG. 1. Additionally, the triggering module 530 and the data collector module 540 may be native to the operating system 510.

The time-associated data sources 505 may be any source of time-sensitive data including, for instance, an application run by the operating system. For instance, a calendar application, and task reminder application, a log application, a diary application, and so forth, are prime sources of time-associated data. The time associated data sources 505 may include one or more programs that are local to the computing system 500 (e.g., that are run by the operating system 510), and or one or more programs that are remote from the computing system 500 (e.g., a program running in a cloud computing environment). Accordingly, there is no limit to the types of time-associated data sources included within the time-associated data sources 505. They may be local to, and/or remote from, the computing system 500 and may perform any function.

The collection operation (of both time-associated data and corresponding presentation instructions) is represented by arrows 506A through 506C from each of the time-associated data sources 505A through 505C. In some embodiments, the time-associated data collector module 540 provides at least some of the collected time-associated data and presentation instructions to the time user interface module 520 for presentation within the time user interface in accordance with the presentation instructions. In one embodiment, as the external time-associated data is collected, the collected time associated data and presentation instructions may then be placed into a time-associated data store 550. The data store 550 may be any device and/or system capable of storing data such as, for instance, a file, a database, or the like. The arrow 503A represents the collected time-associated data being placed into the time associated data store 550.

The time associated data store 550 may be subscribable such that time-sensitive data satisfying the subscription is provided to the executable component that subscribed. Each subscribing executable component correspondingly receiving time-associated data within a scope of the corresponding subscription. With respect to external programs, such subscriptions and responses thereto may be handled by, for instance, the API 560. Alternatively or in addition, the time associated data store 550 is queriable so as to receive query, interpret queries, and provide responsive time-associated data (and corresponding presentation instructions) in response to the query. With respect to external programs, such queries and response thereto may also be handled by the API 560. The API 560 may also provide discovery functions whereby external programs may discover the common services offered by the time-associated data collector, the presence of certain types of time-associated data, and/or the granularity with which presentation instructions may be provided and honored. Alternatively or in addition, the presentation instructions may be separately provided to the time user interface module 520 and tracked on a per-program basis.

Thus, the time user interface module 520 may populate time-associated data into the time user interface 521 by querying the time associated data store. Furthermore, the resulting time-associated data may be displayed in accordance with the presentation instructions provided by the program that provided the time-associated data. This query may be generated once by, for instance, the triggering component 530 activating (as represented by arrow 501) the time user interface module, or may occur in advance of that trigger.

Whether via subscription or query (or some other means), this flow of time-associated data from the time-associated data store 550 to the time user interface module 520 is represented by arrow 503B. In alternative embodiments, the time user interface module 520 may access the time-associated data directly from the time-associated data collector module 540 as represented by arrow 504. Recall again, the corresponding presentation instructions may also be provided at the time, or in advance of, receiving the time-associated data to be displayed.

When triggered, the time user interface module 520 presents a time user interface 521 that is populated with at least some of the time-associated data that was collected by the collector module 540, and in which the display is affected by the presentation instruction provided by the source of the time-associated data. Furthermore, the time-associated data that is populated is dependent on the focal date of the time user interface 521. If that focal date is the current date, then the time-associated data associated having a time that is related to the current date is displayed. If the user navigates to a different focal date in the time user interface 521, then the time-associated data changes so that the time user interface 521 is populated by the time-associated data having a time that is related to the changed focal date. The time-associated data that populates the time user interface 521 may come directly from the collector module 540 (as represented by arrow 504), or may come indirectly from the collector module 540 (e.g., via the time associated data store 550—as represented by arrows 503A and 503B). Nevertheless, a change in the focal date of the time user interface 521 also causes a change in the time-associated data that the time user interface module uses to populate the time user interface.

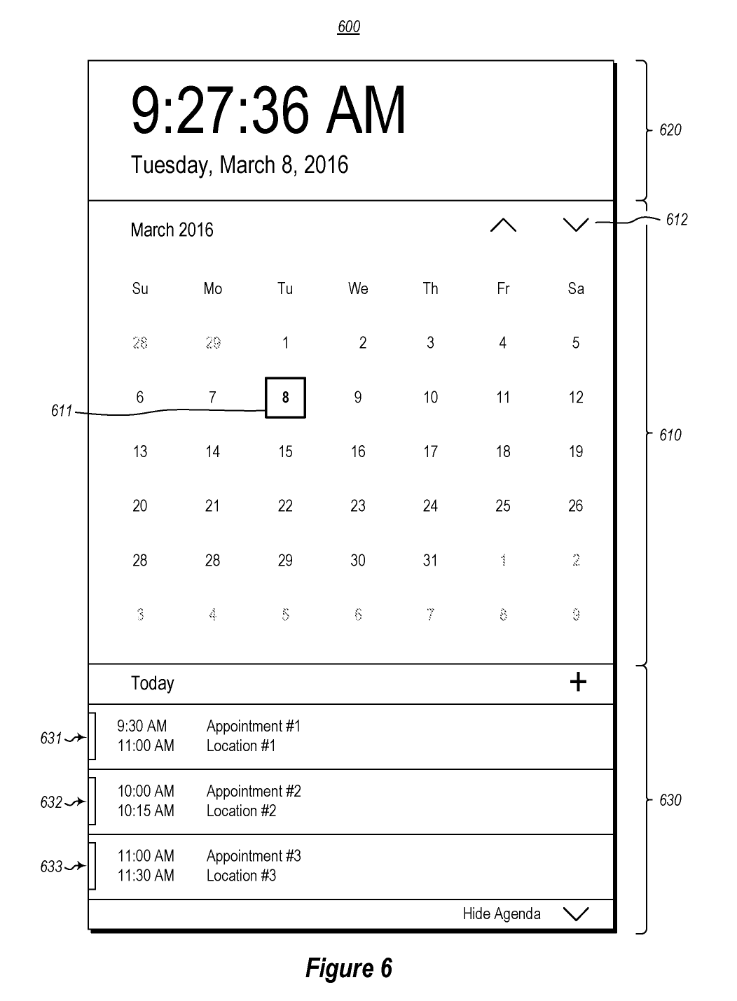

FIG. 6 illustrates a time user interface 600 that represents an example of the time user interface 521 of FIG. 5. The time user interface 600 includes a month view 610 that visually emphasizes the focal date 611. For instance, as a default, when triggered the time user interface 600 may have a focal date of today. The time user interface also has a current time view 620 that shows the time to the second. There are also navigation controls 612 that allow the user to navigate to a different month of the same year, or other months of other years. The user is able to change the focal date, and corresponding external time-associated data related the changed focal date is populated within the time user interface. As an example, there may be a special time-associated data portion of the time user interface that shows the populated time-associated data. This is the case with FIG. 6, which shows that the time user interface 600 includes a time-associated data portion 630. In the state of FIG. 6, the focal date is the current date (which for purposes of this example is Mar. 8, 2016).

Unlike conventional native time user interfaces, the program that provides the time-associated data also provides the instructions for presenting or displaying the time-associated data within the time user interface. For instance, such presentation instructions may be provided by the data sources 505 via the API 560 in FIG. 5. Such presentation instructions may be provided synchronously with the time-associated data, or the presentation instruction may be provided separate from the time-associated data.

The principles described herein are not limited to the types of presentation instructions that are supported by the operating system. As examples only, the presentation instruction could be for the time user interface to use a common operating system element and/or formatting in order to display time-associated data. The presentation instruction could also be for the time user interface to use a default operating system element and/or formatting in order to display time-associated data. The presentation instruction could also be for a specific user interface element and/or formatting to display the time-associated data. The presentation instruction might also provide guidelines for display, which the operating system may use to intelligently decide what user interface element and/or formatting to use in presenting time-associated data. The presentation instruction might also be for the operating system itself to decide what user interface element and/or formatting to use in presenting time-associated data.

In one embodiment, the program may so instruct such that the interface element used to display (and/or the displayed format) of time-associated data within the entries of the time user interface (e.g., within the portions 630) remain consistent with the format of how the time-associated data is represented within the external data source 505 that provided the time-associated data. Thus, the user may recognize the formatting and interpret the data just as they did when interfacing directly within the external data source (e.g., a calendar application). Furthermore, the user may have an understanding of where the time-associated data came from based on recognition of this formatting.

The user may trigger the operating system native time user interface module 520 to present the time user interface by using a consistent gesture to interface with the triggering component 530 regardless of the context in which the computing system 500 operates. For instance, regardless of which applications are running, the same gesture may be used to display the time user interface 521, allowing the user to use mental muscle memory to gain rapid familiarity with accessing and using the time user interface 521. In the illustrated example of FIG. 6, the time-associated data is obtained from a calendar application, and thus the example shows a list of three appointments scheduled for Mar. 8, 2016. This includes appointment #1 (at location #1) shown as entry 631, appointment #2 (at location #2) shown as entry 632, and appointment #3 (at location #3) shown as entry 633. However, this is for purposes of example only. The time-associated data may be sourced from any number of similar or dissimilar external sources.

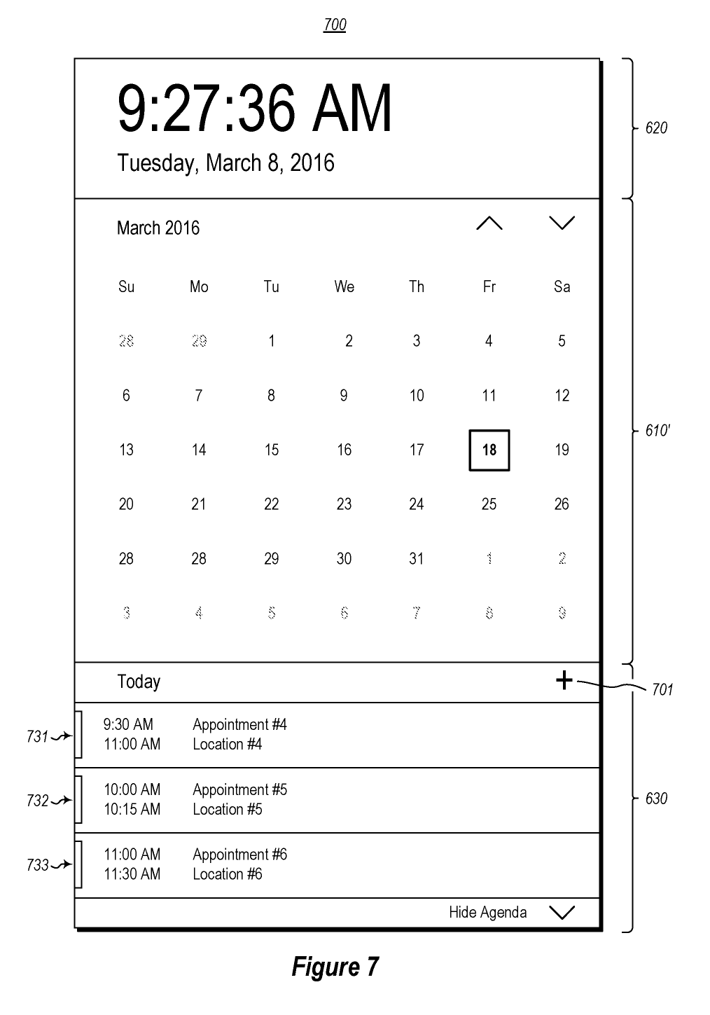

By changing the focal date, the time-associated data changes also. For instance, FIG. 7 illustrates a time user interface 700 that has been altered due to the user selecting Mar. 18, 2016, causing portion 610 with Mar. 8, 2016 highlighted in FIG. 6 to change to portion 610′ with Mar. 18, 2016 highlighted in FIG. 7. In one embodiment, the current time view 620 stays the same so that the user still has a view on the current time. However, the content of portion 630 of FIG. 6 has been altered to result in portion 630′ of FIG. 7. Now, different calendar appointments are shown for Mar. 18, 2016. This includes appointment #4 (at location #4) shown as entry 731, appointment #5 (at location #5) shown as entry 732, and appointment #6 (at location #6) shown as entry 733.

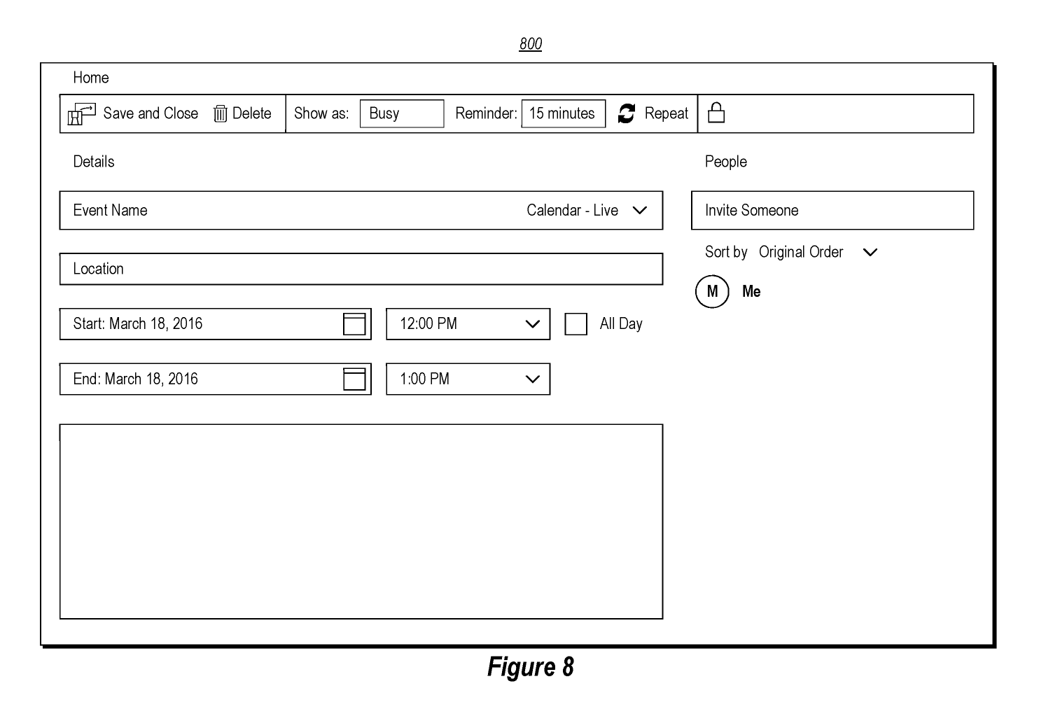

In one embodiment, if application program served as a source of the time-associated data within the time user interface, the user might actually launch the program by interfacing with the time-associated data included within the time user interface. For instance, suppose that the user selected the control 701 of FIG. 7. This might open up the calendar application itself, giving the user an opportunity to enter a new appointment for Mar. 18, 2016 directly in the calendar application. For instance, upon selecting control 701 of FIG. 7, the user interface 800 of FIG. 8 may appear. Note that the user interface 800 already has filled in the date for the appointment. Thus, the application opens with the correct context. Had the user instead selected the entry 731, the user interface 800 may have opened with the entire appointment already populated (e.g., with an “Event Name” of “Appointment #4”, with a “Location” of “Location #4, and with the appropriate start and end time already being filled in).

This created or edited time-based content can then be synced to some database such as data store 550 and any program can take advantage of that new content (e.g., via subscribing to the data store 550 as mentioned above). For instance, if a new appointment is created for a particular date, the next time the time user interface is displayed for that date, the time user interface will display that new appointment. That new appointment may also be available to any program that is authorized to access that new appointment time-associated data. Alternatively, the presentation instructions provided by a program might also give edit control instructions that allow the user to edit or create program data corresponding to the time-associated data by interfacing with the time user interface.

The edit control instruction might also restrict the use of the time user interface such that the user is restricted from editing or create one or more or even all of the program data corresponding to the time-associated data displayed in the time user interface. As one example, the program might have time-associated data in the form of a reminder displayed in the time user interface. The user might be granted control to dismiss the reminder in the context of the time user interface, but not grant the ability to remove the appointment that triggered the reminder. The time user interface may thus be used as a consolidated point for multiple programs (e.g., calendar application or task applications) to provide reminders.

Alternatively or in addition to launching an application from the time user interface offered by the operating system, application program may likewise launch the time user interface offered by the operating system. For instance, suppose that a user was making a flight reservation, and it has now come time to enter the dates of the flight departure and return. Instead of the application itself providing the calendar view, the application might instead use the API 560 offered by the operating system 510 to activate the time user interface 521. That way, the user can now select the dates of travel with full knowledge of other time-associated data (e.g., appointments, anniversaries, birthdays) relevant to the dates of travel, thus allowing the user to make more intelligent decisions about the best times to travel taking into consideration all of the time-associated data. A program might also trigger the time user interface to display with time-associated data in the form of a reminder at the instruction of the program. Accordingly, the time user interface 521 may be treated as a single consolidated area where the user may be reminder of any type of event, regardless of where the reminder originated.

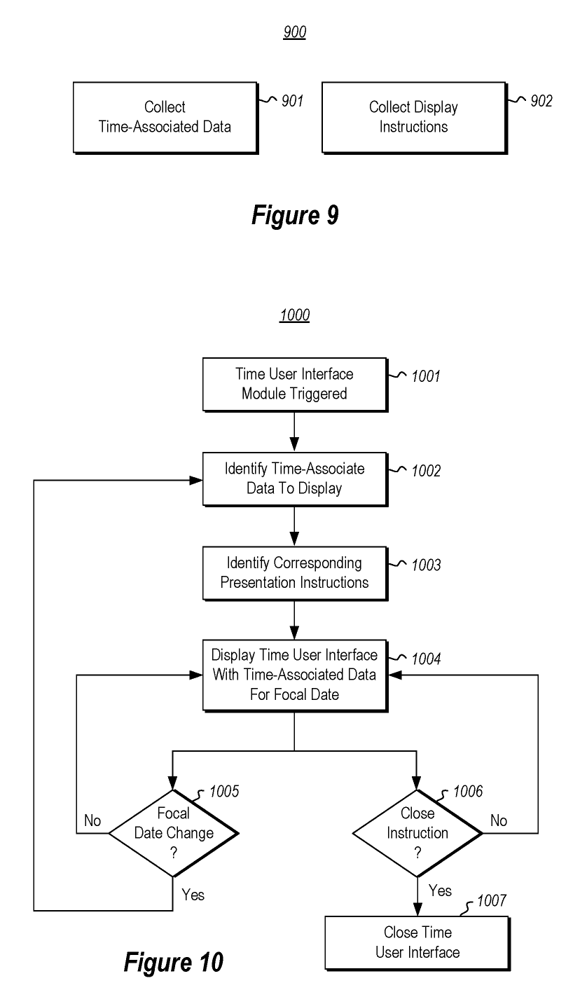

Now methodology will be further described with respect to flowcharts. FIG. 9 illustrates a flowchart of a method 900 for collecting data sourced from external to the operating system. The method 900 is performed by the time-associated data collector module 540 and includes collecting time-associated data from at least one source outside of the operating system (act 901). This may be an act that is continuously performed by the collector module 540, at least for time-associated data that may potentially be subscribed to or used to populate the time user interface. Likewise, the time-associated data collector module 540 (or the user interface module or other operating system module) collects display instructions corresponding to the time-associated data from at least one source outside of the operating system (act 901). Note that the display instructions may correspond one-to-one with particular time-associated data. In other embodiments, however, the display instructions may be provided for higher granularity (e.g., for all time-associated data form the program, for all time-associated data of a particular type from the application, and so forth). Recall that the display instructions may also include edit control instruction providing the extent to which the user may edit or create program data via the time user interface.

FIG. 10 illustrates a flowchart of a method 1000 for presenting an operating system native time user interface that displays time-associated data sourced from external to the operating system, that depends on a focal date of the time user interface, and that is displayed in accordance with presentation instructions from the program that sourced the time-associated data. The method 1000 is performed by the time user interface module 520 and includes mechanisms for responding to changes in the focal date.

First, it is detected that the user has triggered the user interface module to act (act 1001). For instance, in FIG. 5, the user interface module 520 may receive a signal (as represented by arrow 501) from the triggering component 530. The operating system native time user interface module responds by identifying the time-associated data to display (act 1002), by identifying how the time-associated data is to be displayed (act 1003) by for instance, following the presentation instructions provided by the program that provided the identified time-associated data, and by presenting a time user interface of the display (act 1004) with the identified time associated data displayed in the identified manner. For instance, in FIG. 5, the time user interface module 520 presents (as represented by arrow 502) the time user interface 521.

As previously noted, the time user interface allows a change in focal date. If a change in focal date is not detected (“No” in decision block 1005) and a close instruction is not received for the time user interface (“No” in decision block 1006), then the time user interface simply continues to be displayed (act 1004). If a change in focal date is detected (“Yes” in decision block 1005), then time-associated data for the new focal date is identified (act 1002), the manner of display for the new time-associated data is identified (act 1003) and the new time-associated data is displayed in the time user interface (act 1004) as instructed. If a close instruction is received (“Yes” in decision block 1006), then the time user interface is closed (act 1007).

In some embodiments, the visualized characteristics of the time user interface may be altered depending on the focal date. For instance, if the focal date is New Year's Day, perhaps animated fireworks might appear in the time user interface (as an example, in the time-associated data portion 630). The visualized characteristics alternatively be a function of the user of the computing system. For instance, the visualized characteristics may also be personalized to a user's preference. The visualized characteristics may also be a function of both the user and the focal date. For instance, if the focal date is the user's birthday, party hats and animated streamers and confetti may appear in the time user interface. If it is the user's loved one's birthday, perhaps the same animation appears, but with a backdrop showing the loved one's picture.

In addition, the types of time-associated data may be customized based on any context. For instance, perhaps during work hours, calendar appointments are shown, but during night hours, reflections over the last month are shown. On New Year's Eve, perhaps reflections on major events of the year are shown in the time-associated data. Accordingly, as context changes, the time-associated data populated into the time user interface still is related to the focal date, but how it is related may change. For New Years' even, it is a retrospective relation. For a current workday, it may be a “occurring today” relation. Accordingly, when changing a focal date, the query to the data store may have different parameters, depending on context. The presentation instructions provided by the program that sourced the time-associated data may also provide instructions for such customization and personalization of the time user interface depending on context.

Thus, the principles described herein provide a mechanism for the user to access a significantly enhanced time user interface operated by the operating system, but which is populated by time-associated data from external program(s) and in a manner that is instructed by the external program(s). Thus, the user can get a sense of the time-associated data related to any date as desired by the user, and may obtain such data via an operating system-based user interface. This provides a consistent mechanism for a user to access time-associated data, regardless of the source of the time-associated data being external to the operating system, regardless of the date, and regardless of what applications are running in the operating system. Furthermore, navigation through focal dates to see different external time-associated data is also able to be performed in a consistent manner based on interaction with the operating system. The manner if visualizing the time-associated data, and even the identity of the time-associated data in its content and relation to the focal date, may also be customized, providing the user a rich experience.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising an operating system that comprises:
a time associated data collector module that is native to an operating system that collects external time-associated data from at least one program that is not native to the operating system, and that collects presentation instructions from the at least one non-native program regarding how to display corresponding time-associated data from that non-native program;
an operating system native time user interface module that presents a time user interface of the display, the time user interface allowing a change in focal date; and
a time user interface module that populates the time user interface with at least some external time-associated data that was collected by the time associated data collector module and that is dependent on the focal date of the time user interface, such that a change in the focal date of the time user interface also causes a change in the time-associated data that the time user interface module uses to populate the time user interface, and such that the time-associated data populated into the time user interface is displayed in accordance with the presentation instruction(s) received from the non-native program that sourced the time-associated data populated into the time user interface.

2. The computing system in accordance with claim 1, the operating system being configured to listen for time-associated data from a plurality of external programs simultaneously.

3. The computing system in accordance with claim 2, the plurality of external programs including at least one local program and at least one remote program.

4. The computing system in accordance with claim 1, the operating system native time user interface module being triggerable to present the time user interface by a consistent gesture regardless of context of the computing system.

5. The computing system in accordance with claim 1, the operating system native time user interface module being triggerable to present the time user interface in response to a communication from a non-native program.

6. The computing system in accordance with claim 5, the communication from the application being triggered by a reminder associated with an event managed by the non-native program.

7. The computing system in accordance with claim 1, further comprising:
a time associated data store that contains external time-associated data collected by the time associated data collector module.

8. The computing system in accordance with claim 7, the external time-associated data that is populated into the time user interface by the time user interface module coming from the time associated data store.

9. The computing system in accordance with claim 1, the external time-associated data that is populated into the time user interface being in a portion of the time user interface.

10. The computing system in accordance with claim 1, the time user interface changing visualized characteristics based on the focal date.

11. The computing system in accordance with claim 10, the visualized characteristics of the time user interface being changed based also on identity of a user of the computing system.

12. The computing system in accordance with claim 1, the presentation instruction(s) received from the non-native program comprising a presentation instruction for the time user interface to display the external time-associated data using a common or default operating system user interface element and/or formatting.

13. The computing system in accordance with claim 1, the presentation instruction(s) received from the non-native program comprising a presentation instruction for the time user interface to display the external time-associated data using a specific user interface element and/or formatting.

14. The computing system in accordance with claim 1, the presentation instruction(s) received from the non-native program comprising a presentation instruction for the time user interface to display the external time-associated data using a specific user interface element and/or formatting.

15. The computing system in accordance with claim 1, the presentation instruction(s) received from the non-native program comprising a presentation instruction for the operating system to at least partially decide what user interface element and/or formatting to use in displaying the external time-associated data.

16. A method for presenting an operating system native time user interface that displays time-associated data sourced from external to the operating system in a manner and that depends on a focal date of the time user interface and in accordance with presentation instructions from non-native programs, the method comprising:
an act of a time associated data collector module collecting time-associated data from at least one source outside of the operating system;
an act of the operating system collecting presentation instructions associated with at least some of the collected time-associated data from at least one source outside of the operating system;
an act of an operating system native time user interface module presenting a time user interface of the display, the time user interface allowing a change in focal date;
an act of a time user interface module populating the time user interface with at least some time-associated data that was collected by the time associated data collector module and that is dependent on a previous focal date of the time user interface, the populated time-associated data being displayed responsive to at least one of the presentation instructions;
an act of detecting a change in the previous focal date of the time user interface; and
in response to the act of detecting the change in the focal data, an act of the time user interface module populating the time user interface with at least some of the time-associated data that was collected by the time associated data collector module and that is dependent on the changed focal data of the time user interface.

17. The method in accordance with claim 16, further comprising:
an act of detecting user interaction of time-associated data included within the time user interface; and
an act of launching an application that provided the time-associated data subject to the user interaction.

18. The method in accordance with claim 16, the act of the time user interface module populating the time user interface with at least some time-associated data that is dependent on the previous focal date of the time user interface comprising:
an act of querying a collection of time-associated data collected by the time associated data collector module using a first query having a first set of one or more parameters.

19. The method in accordance with claim 18, the act of the time user interface module populating the time user interface with at least some time-associated data that is dependent on the changed focal date of the time user interface comprising:
an act of querying again a collection of time-associated data collected by the time associated data collector module using a second query having a second set of one or more parameters that is different than the first set of one or more parameters.

20. A computing system comprising an operating system that comprises:
a time user interface module that presents a time user interface on a display, the time user interface allowing a change in focal date and displays external time-associated data as instructed;
an application program interface that communicatively couples one or more non-native programs with the time user interface module, to thereby allow the one or more non-native programs to provide time-associated data and corresponding presentation instructions to the time user interface module, thereby causing the time user interface to display the external time-associated data sourced from a non-native program to be displayed responsive to instructions from the non-native program.
